(19) United States
(12) Patent Application Publication
(10) Pub. No.: US 2016/0006570 A1
(43) Pub. Date: Jan. 7, 2016

(54) GENERATING A KEY DERIVED FROM A CRYPTOGRAPHIC KEY USING A PHYSICALLY UNCLONABLE FUNCTION

(71) Applicant: SIEMENS AKTIENGESELLSCHAFT, München (DE)

(72) Inventors: Rainer Falk, Poing (DE); Steffen Fries, Baldham (DE)

(21) Appl. No.: 14/770,137

(22) PCT Filed: Jan. 14, 2014
(86) PCT No.: PCT/EP2014/050547

§ 371 Date: Aug. 25, 2015

(30) Foreign Application Priority Data
Feb. 28, 2013 (DE) 10 2013 203 415.6

(51) Int. Cl. H04L 9/32; H04L 9/08

(52) U.S. Cl. CPC H04L 9/3278; H04L 9/0819; H04L 2209/24

(57) ABSTRACT

The embodiments relate to a method and a device for generating a key derived from a cryptographic key using at least one physically unclonable function. At least one request value is assigned to the cryptographic key and to at least one derivation parameter. A response value is generated on a circuit unit using the at least one physically unclonable function dependent on at least one respective request value. The derived key is derived from the at least one response value.

### CROSS-REFERENCE TO RELATED APPLICATIONS

The present patent document is a §371 nationalization of PCT Application Serial Number PCT/EP2014/050547, filed Jan. 14, 2014, designating the United States, which is hereby incorporated by reference, and this patent document also claims the benefit of DE 10 2013 203 415.6, filed on Feb. 28, 2013, which is also hereby incorporated by reference.

### TECHNICAL FIELD

The present embodiments relate to a method and a device for generating a derived key from a cryptographic key using at least one physical unclonable function.

### BACKGROUND

To carry out cryptographic methods, cryptographic keys are used. For example, the cryptographic keys are used in symmetric encryption methods in order to encrypt a communication between two devices. Likewise, cryptographic keys are used in authentication methods. Key management for cryptographic keys includes, for example, the generation, distribution, and storage of a cryptographic key. In addition, for many applications, the derivation of a plurality of keys from one cryptographic key is used since, for example, different keys are assigned to different devices during device communication.

Key derivation functions (KDFs) are known. They determine a derived key deterministically as a function of an input key and a derivation parameter. Therefore, cryptographic algorithms, which secure the requirements placed on the derived key, are used.

The use of a physical unclonable function, abbreviated below as PUF, is known for determining a cryptographic key. The PUF is supplied with a challenge value, also referred to below as a challenge, and a cryptographic key is generated from a response value, also referred to below as a response, with the aid of a key extraction function. The key may be unambiguously generated by so-called auxiliary data using error correction methods, even in the case of statistical fluctuations to which the response is subjected. Thus, the same key is reliably generated if, for example, the circuit on which the PUF is implemented is not destroyed.

### SUMMARY AND DESCRIPTION

The scope of the present invention is defined solely by the appended claims and is not affected to any degree by the statements within this summary. The present embodiments may obviate one or more of the drawbacks or limitations in the related art.

The object of the present embodiments is to provide a method and a device that make possible a simplified key derivation of a derived key from a cryptographic key.

A method for generating a derived key from a cryptographic key includes the following acts. At least one challenge value is assigned to the cryptographic key and to at least one derivation parameter. A response value is generated on a circuit unit by at least one physical unclonable function as a function of at least one challenge value in each case. The derived key is derived from the at least one response value.

A physical unclonable function (PUF) is understood to be, in particular, a function that generates a response value when a challenge value is passed to it. PUFs are known from the related art in various embodiments and identify objects reliably based on an intrinsic physical characteristic. A physical characteristic of an object, for example, of a semiconductor circuit, is used as an individual fingerprint. A PUF defined via the physical characteristic provides a response value associated with the object as a function of a challenge value.

A cryptographic key is understood to be a key that already exists in an initial situation of a key derivation method and which is used as a primary key or master key in order to generate multiple other keys.

In the present application, a cryptographic key is also understood to be a key that meets requirements of the encryption method in which it is used, for example, a sufficient key length.

A derived key is understood to be a key generated from an existing cryptographic key, for example, a primary key stored in a particularly secure manner on a device, or a configurable or readable primary key. A derived key is also subject to requirements with respect to cryptographic security, which vary depending on the application.

A key derivation function that is customized by a PUF is provided with the aid of the described method. The calculation result of the key derivation is a function of the hardware, (for example, the chip), on which the method for key derivation is carried out.

Unlike methods known from the related art, the method may be implemented in hardware with low circuit complexity, since no cryptographic algorithms are required.

The derived key may be used as the session key for cryptographically protected data communication, for example, according to the IEEE MAC Security Standard (MACsec IEEE802.1ae), according to Internet Protocol Security (IPsec), or according to Transport Layer Security (TLS). Furthermore, the derived key may be used for decrypting a software module for purposes of copy protection, or for checking a cryptographic checksum of a software module or configuration data. Furthermore, the cryptographic key may be used for encrypting and decrypting a data carrier or a portion of a data carrier (for example, a partition), a directory, or individual files. The derived key may be used for cryptographic algorithms such as DES, AES, MD5, and SHA-256, and also as a key parameter of a pseudo-random number generator or a shift register configuration. Using such a pseudo-random number generator or such a shift register configuration, a noise signal or spreading signal may be generated that is used in a modulation method, (for example, a radio transmission link). This has the advantage that a protected information transmission may be implemented on extremely limited environments such as a physical sensor or an RFID tag, on which no conventional cryptographic algorithm is implemented.

Due to the dependency of the derived key on the derivation parameter, an earmarked key is generated, the purpose of which is controllable via the derivation parameter.

The term “purpose” is to be understood in the present application as a piece of information with which the derived key is tightly linked via the key derivation method. For example, if a derived key is used for purposes of authentication, the key is valid only if the purpose of the derived key used in the key derivation matches the purpose that is also passed to the authenticating instance or assigned to the authenticating instance.

Thus, a method is provided, which, on the one hand, makes possible a hardware-characterizing generation of a derived key as a function of the hardware on which the derived key is generated. Simultaneously, different keys may be generated with the aid of the derivation parameter by a PUF implemented on a circuit unit of a piece of hardware. Thus, a key duplication method is provided that generates keys as a function of the circuit unit, wherein the keys are not able to be reproduced on a second circuit unit.

According to one refinement, at least two challenge values are assigned to the cryptographic key and the at least one partition parameter.

Thus, determination is made on the basis of cryptographically strong keys in the case of a possibly weak PUF that does not reliably utilize the available key space in a single query by a challenge value.

By assigning at least two challenge values, an extended value range is generated for the challenge value, so that an associated unique derived key is generated with high probability for a determinable derivation parameter.

For example, a second challenge value may be assigned to a first derivation parameter by incrementing a first challenge value. Furthermore, a concatenation of the first challenge value with a counter value that, for example, is binary coded, is possible.

According to another refinement, one of at least two response values is generated as a function of the at least two challenge values.

The physical unclonable function is supplied successively with the challenge values, and a response value is generated per challenge value.

According to another refinement, two or more physical unclonable functions are each supplied with at least one challenge value on the circuit unit, and one response value, which is a function of the at least one challenge value, is generated in each case.

According to one refinement, the derived key is derived from the at least two response values.

For example, an input value is generated from the at least two response values, which is formed via a concatenation of the at least two response values. The derived key is generated as a function of the input value by a key extraction method.

Furthermore, the input value for the key extraction may be determined via exclusive-OR operations on the at least two challenge values.

Furthermore, one pre-key may be calculated initially in each case for the at least two response values, wherein a key extraction is carried out for each of the at least two response values. The derived key is determined as a function of the pre-keys, for example, as a concatenation of the pre-keys, as an exclusive-OR operation on the pre-keys, or by a hash function.

According to another refinement, the cryptographic key is generated by the at least one physical unclonable function.

Thus, the cryptographic key may be generated by the at least one physical unclonable function existing on the circuit unit. This minimizes both the calculation and hardware complexity in a key derivation method. Furthermore, no cryptographic algorithm is needed for calculating the cryptographic key. For example, the same PUF is used for both the creation of the cryptographic key and the derivation of the derived key. Therefore, the security requirements for storing a master key do not have to be particularly high, since the circuit unit with the PUF constitutes a key memory that is destroyed if an attempt is made to read out the key.

According to one embodiment, the circuit unit is designed as an integrated semiconductor circuit unit.

This circuit unit may be an analog integrated semiconductor circuit unit, a so-called mixed-signal integrated circuit unit including analog and digital circuit units, a digital integrated semiconductor circuit unit (e.g., application-specific integrated circuit or ASIC), or a programmable integrated semiconductor circuit unit (e.g., field-programmable gate array (FPGA), central processing unit (CPU), system on chip). This has the advantage that such integrated circuit units are available inexpensively and in high quantities and have a compact size.

According to one embodiment, the at least one physical unclonable function is designed as a delay PUF, an arbiter PUF, an SRAM PUF, a ring oscillator PUF, a bistable ring PUF, a flip-flop PUF, a glitch PUF, a cellular nonlinear network PUF, or a butterfly PUF. Thus, a suitable PUF variant may be selected as a function of the basic conditions, for example, the available circuit area, the physical implementation of the integrated semiconductor circuit unit, demands on power consumption or propagation time, or the requested security level.

According to one advantageous refinement, the derivation parameter is formed from at least one earmarking parameter.

Thus, a method is created in which a specific purpose is assigned to the derived key. The derived key may, for example, be used with different communication partners of a device for a specific communication. A different key is derived for each purpose. This has the advantage that that a key is valid for a specific purpose and is simultaneously not valid for a purpose differing from the specific purpose. Thus, the risk of misuse is reduced.

According to one advantageous embodiment, the earmarking parameter is selected from one of the following parameters: a network address, a node identifier, an interface identifier, an identifier of an application, a piece of content of a data packet, a random value, a counter value, a character string or bit sequence that is dedicated to a purpose, a piece of version information about a software module or a firmware image, a serial number of a central processing unit, a parameter made up of a piece of contextual information about an environment, or a checksum of a data block or of configuration parameters. Thus, key management is facilitated in the event that, for example, a plurality of different keys is provided for a plurality of applications.

A key update is achieved in a simple manner via a renewable earmarking parameter.

A device is also provided for generating a derived key from a cryptographic key, including a circuit unit having at least one physical unclonable function, a first unit for ascertaining at least one challenge value as a function of the cryptographic key and at least one derivation parameter, a second unit of the circuit unit for generating a response value by the at least one physical unclonable function, as a function of the at least one challenge value, and a third unit for deriving the derived key from the at least one response value.

According to one embodiment, the device includes at least one additional unit for use in one of the method acts according to the above-described embodiments or refinements of the method.

### BRIEF DESCRIPTION OF THE DRAWINGS

FIG. 1 depicts a schematic representation of a method for generating a derived key from a cryptographic key, and units of a device for generating a derived key from a cryptographic key according to one embodiment.

FIG. 2 depicts a schematic representation of a method for creating a derived key from a cryptographic key according to another embodiment.

### DETAILED DESCRIPTION

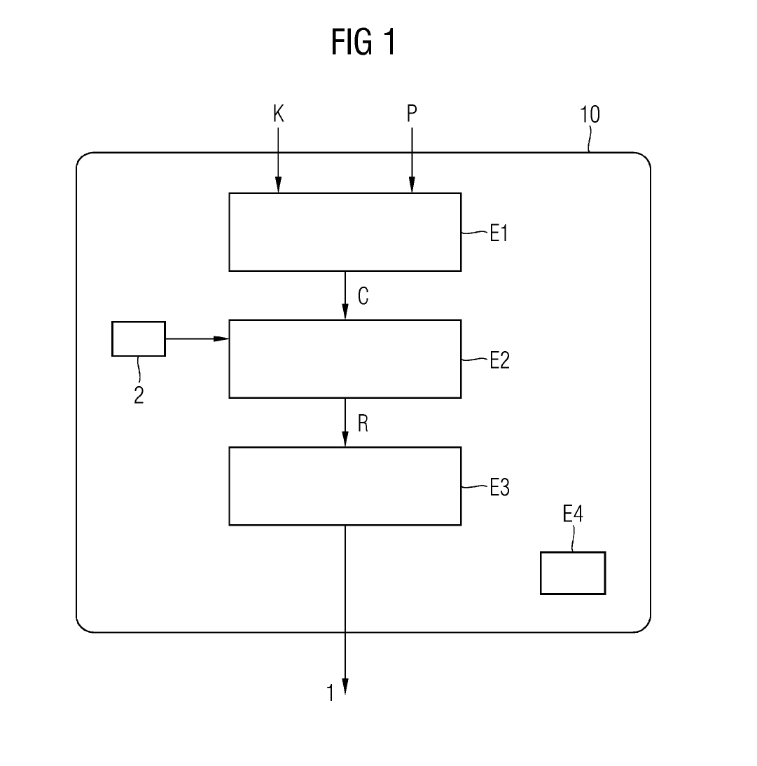

FIG. 1 schematically depicts, according to a first exemplary embodiment, how a derived key 1 is generated from a cryptographic key K and a derivation parameter P on a device 10. A challenge value C is assigned to a combination made up of the cryptographic key K and the derivation parameter P. For example, the cryptographic key K is a random number sequence having a length of 32 bits, 64 bits, 128 bits, or 256 bits. The cryptographic key K is used as a master key and stored securely. For example, the master key is stored in so-called polyfuses within an FPGA. Polyfuses are known from the related art. The polyfuses are non-volatile and may be programmed only once.

The number of different derived keys may be determined via the number of derivation parameters P. It is, for example, conceivable that a network node uses a different key to encrypt the communication with each other network node with which it communicates. To do this, a different derivation parameter P is determined for each communication link. A communication within a network encrypted with the aid of symmetric encryption is also encrypted as a function of a purpose, e.g., the communication partners.

The challenge value C is determined on a first unit E1 from the derivation parameter P and the cryptographic key K by a hash function, for example, a cyclic redundancy check (CRC). To determine the challenge value C, a central processing unit is provided that is specifically designed for this purpose. This is in particular advantageous in the case of high computing complexity when determining the challenge value C, for example, for a challenge value range on the order of magnitude of a billion challenge values.

The derivation parameter P specifies, for example, the IP address, which is: IP-192.168.13.12.

The assigned challenge value C is a value with which a so-called physical unclonable function (PUF) 2 is now supplied. The PUF 2 is, for example, implemented on an integrated semiconductor circuit and is designed as a so-called delay PUF. Delays of a signal within ring oscillators may thus, for example, be evaluated, and are an unambiguous characteristic of circuits, due to unavoidable irregularities in the physical structure due to the manufacturing process. Likewise, other PUF variants may be used instead of a delay PUF, for example, an arbiter PUF or a butterfly PUF.

Thus, a response value R associated with the specific challenge value C is generated from the cryptographic key K and the derivation parameter P, whose value is characteristic of the PUF 2 embedded in the circuit unit. An identical response value R may not be generated on a second circuit unit. The derived key 1 is derived from the response value R.

In this way, it is simultaneously possible to keep the computation complexity on a circuit unit low during a key derivation method and to provide a high level of security. Unlike methods from the related art for key derivation, by using the PUF 2 for generating the derived key, no cryptographic algorithm is required. However, a key derivation is in particular possible only on a device that is provided for this purpose.

A derivation of a key for decrypting a data carrier or a portion of a data carrier that corresponds to a key generated for encrypting the data carrier or the portion of the data carrier is possible only on the device having the integrated circuit on which the key for encryption was also derived. This is in particular the device on which the encryption is to be carried out.

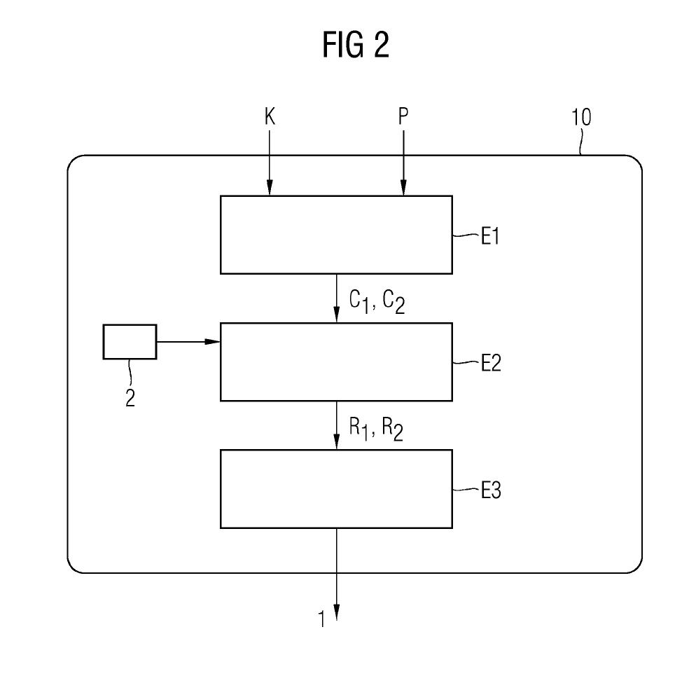

According to a second exemplary embodiment, multiple challenge values C1, C2 are assigned from the cryptographic key K and the derivation parameter P. FIG. 2 depicts a schematic flow chart for this embodiment. For example, challenges C1, C2 are determined for which associated responses R1, R2 are ascertained by a PUF 2. This has the advantage that strong keys are able to be determined even in the case of a weak PUF that does not reliably utilize the available key space in a single query. The response value R1 ascertained per challenge value C1 is derived for an earmarked key.

An earmarking parameter that specifies the purpose of the earmarked key exists, for example, in the form of a character sting. Multiple associated intermediate parameters are now generated for an earmarking parameter, by, for example, concatenating the earmarking parameter with a different character string. Thus, different intermediate parameters result from the earmarking parameter via an artificially induced duplication.

Similarly to determining a challenge value C1 for a single derivation parameter, for determining the challenge value C1 per individual intermediate parameter, a cyclical redundancy check or a calculation is carried out by a hash function, (in particular, MD5, SHA-1, SHA256, etc.). A number of challenge values C1, C2 now exist as a function of the number of intermediate parameters duplicated from the earmarking parameter.

In this exemplary embodiment, a parameter from a piece of contextual information of an environment is evaluated as an earmarking parameter. For example, the checksum of a piece of data and an identifier of a maintenance technician are ascertained simultaneously. Intermediate parameters are derived via the described duplication method. The use of a piece of contextual information for the key derivation makes possible a generation of a plurality of session-specific keys. A session-specific key is intended in particular to be unique to each assignment of the maintenance technician.

The method according to the second exemplary embodiment is carried out on a device 10 designed as a circuit unit.

The described method for determining the challenges C1, C2 is carried out on a first unit E1 on the circuit unit. The PUF 2 characterizes this circuit unit unambiguously. In the function of a second unit E2, the PUF 2 is supplied with the assigned challenge values C1, C2 and provides an associated response value R1, R2.

Now, the derived key is derived on a third unit E3 that is also part of the circuit unit in this exemplary embodiment. The generated response values R1, R2 may be thus evaluated as a quantity or as a list having a sequence to be taken into account. For example, an overall response value is initially calculated, which results from an exclusive-OR operation on the individual response values R1, R2. Alternatively, the overall response value may be ascertained as a concatenation of the individual response values R1, R2. Alternatively, a pre-key K1, K2 may be generated from each of the response values R1, R2, and in a second act, these pre-keys K1, K2 may be linked to the derived key, in particular, via an exclusive-OR operation. Otherwise, the overall response value is transmitted to the key derivation function and the derived key is derived from it.

The derived key is provided via an output unit of the third unit E3.

The method according to the second exemplary embodiment makes possible the generation of a derived key even in the case of a limited value range for challenges, in which different derived keys are also generated with high probability for different earmarking parameters.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for generating a derived key from a cryptographic key, the method comprising:
assigning at least one challenge value to the cryptographic key and to at least one derivation parameter;
generating a response value on a circuit unit by at least one physical unclonable function as a function of the at least one challenge value; and
deriving the derived key from the at least one response value.

2. The method as claimed in claim 1, wherein at least two challenge values are assigned to the cryptographic key and the at least one derivation parameter.

3. The method as claimed in claim 2, wherein one of at least two response values is generated as a function of the at least two challenge values.

4. The method as claimed in claim 3, wherein the derived key is derived from the at least two response values.

5. The method as claimed in claim 3, wherein two or more physical unclonable functions are each supplied with the at least one challenge value on the circuit unit, and one response value, which is a function of the at least one challenge value, is generated in each case.

6. The method as claimed in claim 1, wherein the cryptographic key is generated by the at least one physical unclonable function.

7. The method as claimed in claim 1, wherein the circuit unit is an integrated semiconductor circuit unit.

8. The method as claimed in claim 1, wherein the at least one physical unclonable function is a delay PUF, an arbiter PUF, an SRAM PUF, a ring oscillator PUF, a bistable ring PUF, a flip-flop PUF, a glitch PUF, a cellular nonlinear network PUF, or a butterfly PUF.

9. The method as claimed in claim 1, wherein the derivation parameter is formed from at least one earmarking parameter.

10. The method as claimed in claim 9, wherein the earmarking parameter is selected from one of the following parameters: a network address, a node identifier, an interface identifier, an identifier of an application, a piece of content of a data packet, a random value, a counter value, a serial number of a central processing unit, a parameter made up of a piece of contextual information about an environment, or a checksum of a data block.

11. A device for generating a derived key from a cryptographic key, the device comprising:
a circuit unit having at least one physical unclonable function;
a first unit for ascertaining at least one challenge value as a function of the cryptographic key and at least one derivation parameter;
a second unit of the circuit unit for generating a response value by the at least one physical unclonable function, as a function of the at least one challenge value; and
a third unit for deriving the derived key from the at least one response value.

12. The device as claimed in claim 11, further comprising at least one additional unit for forming the derivation parameter from at least one earmarking parameter.

13. The device as claimed in claim 12, wherein the earmarking parameter is selected from one of the following parameters: a network address, a node identifier, an interface identifier, an identifier of an application, a piece of content of a data packet, a random value, a counter value, a serial number of a central processing unit, a parameter made up of a piece of contextual information about an environment, or a checksum of a data block.

14. The device as claimed in claim 11, wherein the circuit unit is an integrated semiconductor circuit unit.

15. The device as claimed in claim 11, wherein the at least one physical unclonable function is a delay PUF, an arbiter PUF, an SRAM PUF, a ring oscillator PUF, a bistable ring PUF, a flip-flop PUF, a glitch PUF, a cellular nonlinear network PUF, or a butterfly PUF.

16. The method as claimed in claim 4, wherein two or more physical unclonable functions are each supplied with the at least one challenge value on the circuit unit, and one response value, which is a function of the at least one challenge value, is generated in each case.

17. The method as claimed in claim 16, wherein the cryptographic key is generated by the at least one physical unclonable function.

18. The method as claimed in claim 17, wherein the circuit unit is an integrated semiconductor circuit unit.

19. The method as claimed in claim 18, wherein the at least one physical unclonable function is a delay PUF, an arbiter PUF, an SRAM PUF, a ring oscillator PUF, a bistable ring PUF, a flip-flop PUF, a glitch PUF, a cellular nonlinear network PUF, or a butterfly PUF.

20. The method as claimed in claim 19, wherein the derivation parameter is formed from at least one earmarking parameter.
